(19) United States
(12) Patent Application Publication
(10) Pub. No.: US 2026/0022589 A1
(43) Pub. Date: Jan. 22, 2026

(54) Mobile Lock for Securing a Mobile Object

(71) Applicant: pewag Schneeketten GmbH, Graz (AT)

(72) Inventor: Gert Rheina-Wolbeck, Feldkirchen (AT)

(21) Appl. No.: 19/225,882

(22) Filed: Jun. 2, 2025

(30) Foreign Application Priority Data
Jun. 3, 2024 (EP) 24179671.3

(51) Int. Cl. E05B 47/00; E05B 71/00

(52) U.S. Cl. CPC E05B 47/0012; E05B 71/00; E05B 2047/0017; E05B 2047/0024; E05B 2047/0057; E05B 2047/0095

(57) ABSTRACT

The invention relates to a mobile lock for securing a mobile object, wherein the lock can be controlled wirelessly by a mobile device, wherein the lock has a base body and a connecting body which can be locked to the base body. The base body includes the following: a housing; an electric motor; a computing unit for controlling the electric motor, the computing unit being set up to control the electric motor as a function of a signal received by a mobile device; an energy conversion unit for converting electromagnetic energy which can be transmitted via a mobile device, in particular electromagnetic energy which can be transmitted via NFC technology or QI technology, into an electrical voltage for supplying the electric motor and the computing unit; and a mechanical locking system having a locking unit displaceable in relation to the housing and at least one locking element coupled thereto.

### CROSS-REFERENCE TO RELATED APPLICATION

The present application claims the benefit of European Patent Application Serial No. EP 24179671.3, which is incorporated herein by reference in its entirety.

### BACKGROUND OF THE INVENTION

### Field of the Invention

The invention relates to a mobile lock for securing a mobile object, wherein the lock can be controlled wirelessly by a mobile device, wherein the lock has a base body and a connecting body which can be locked to the base body, wherein the base body comprises the following: A housing, an electric motor, a computing unit for controlling the electric motor, the computing unit being set up to control the electric motor as a function of a signal received by a mobile device, an energy conversion unit for converting electromagnetic energy that can be transmitted via a mobile device, in particular via NFC technology or QI technology, into an electrical voltage for supplying the electric motor and the computing unit, and a mechanical locking system comprising a locking unit that can be displaced in relation to the housing and at least one locking element coupled thereto.

### Description of the Related Art

Locks that can be activated by means of electromagnetic energy are known from the prior art. For example, locks are known which have a computing unit and a battery or accumulator which is set up to supply the computing unit, whereby the lock can be locked and unlocked with an app, e.g. via a smartphone. The batteries must be replaced at certain intervals or the rechargeable batteries must be recharged by cable at certain intervals. Such locks are also designed as mobile locks, for example as bicycle locks. A disadvantage of such locks is that the lock can no longer be activated if the accumulator or battery is completely discharged, as the lock lacks the electrical energy required for this. To avoid this problem, attempts have so far been made to increase the energy efficiency and/or the amount of energy stored in the lock so that the time intervals until a complete discharge are increased. In addition, early warning systems can be used which warn the user, for example when using an app, when the charge level of the lock is low and suggest replacing/recharging the energy storage unit.

One task of the invention is therefore to create a lock that is more user-friendly.

### BRIEF SUMMARY OF THE INVENTION

This problem is solved with a lock of the type mentioned at the beginning, in which, according to the invention, the locking unit has the following: At least one locking bolt, a first force means for exerting a force, in particular a spring element, which acts on the at least one locking bolt and exerts a force on the latter which presses the at least one locking bolt towards an end position, a cam disk rotatably connected to the electric motor, wherein the at least one locking bolt is mechanically coupled to the cam disk, so that by a rotary movement of the cam disk the at least one locking bolt can be moved away from the end position towards a release position against the force of the first force means, wherein in the release position of the at least one locking bolt the locking unit can be displaced in relation to the housing, namely from a closed position into an open position and vice versa, and wherein in the end position of the at least one locking bolt the locking unit is fixed in the closed position, and wherein the locking unit has a guide section which is in mechanical engagement with the locking element, namely in such a way that, in the closed position of the locking unit, the at least one locking element is secured against displacement with respect to the housing in such a way that a connecting body mechanically coupled to the base body, in particular pushed onto the latter, is locked with the locking element by mechanical engagement of the at least one locking element in the connecting body, and in an open position of the locking unit, the at least one locking element is displaceable in relation to the housing along the guide section, so that the mechanical engagement with the connecting body can be released.

This solution according to the invention creates a lock that can be controlled by an external device such as a smartphone and at the same time supplied with electrical energy wirelessly. A cable connection for charging the lock and/or a battery compartment for replacing the energy storage unit can therefore be completely dispensed with. The energy can simply be transferred to the lock electromagnetically.

The force means can be realized as a spring element, as a magnet or by other suitable means. The electric motor can, but does not have to, be part of the locking unit. A version is conceivable in which the motor is permanently installed in relation to the housing and the locking unit moves without the motor as long as a rotary movement generated by the motor is transmitted to the cam. The mobile lock according to the invention can be used for a variety of applications in which high mobility and wireless control are particularly advantageous. For example, the use for securing mobile objects such as bicycles, motorcycles, etc. is mentioned. The lock can therefore be used, for example, as a bicycle lock, as a motorcycle lock or as a lock for securing mobile pieces of furniture.

In particular, it may be provided that a second force means is provided within the housing, which exerts a force on the locking unit that pushes the locking unit in the direction of the open position.

Furthermore, it may be provided that, in order to minimize the electrical energy consumption of the lock, the computing unit for controlling the electric motor is configured in such a way that the electric motor is controlled exclusively for transferring the at least one locking bolt from the end position to the release position, and wherein the second force means is dimensioned in such a way that, by transferring the locking bolt to the release position, the locking unit is pressed into the open position from the closed position solely by the force of the second force means.

In particular, it may be provided that the connecting body has a coupling section, in particular in the form of a projection, which coupling section is set up to contact the locking unit when the connecting body is manually pushed onto the base body and to transfer it from the open position to the closed position against the force of the second force means. This can be done, for example, by the user pushing it on manually.

Furthermore, it may be provided that the electric motor is equipped with a gear which is designed to be self-locking.

In particular, it may be provided that the cam disk has at least one mechanical stop that limits a rotary movement to be performed, which is provided for transferring the at least one locking bolt from the end position to the release position. In this way, a defined position of the cam disk is determined after the rotary movement has been completed.

Furthermore, it may be provided that the stop is designed in such a way that a rotary movement to be performed is limited and at the same time, after the rotary movement has been completed, the transition of the at least one locking bolt from the release position to the end position is released by the cam disk, so that when the locking unit is in the closed position, the at least one locking bolt is pressed into the end position with the aid of the first force means.

In particular, it may be provided that the cam disk has four sections, each with a stop, which sections are offset by 90° to each other and are otherwise identical, so that a rotary movement for transferring the at least one locking bolt from the release position to the end position takes place over an angular range of 90°.

Furthermore, it may be provided that the lock has exactly two locking bolts which are arranged opposite each other and the first force means is in the form of a compression spring arranged between these locking bolts, which pushes the locking bolts apart. The advantage of using two opposing locking bolts is that successful manipulation by striking the lock from the outside can be counteracted, since—if one bolt is struck inwards—the other bolt is pressed even more strongly outwards and thus blocks the lock.

In particular, it can be provided that the lock has three locking elements, each of which is designed as a ball, whereby the housing is cylindrical in the area of the locking elements and the balls are arranged on the circumference of the housing in such a way that they are offset from each other by 120° along the circumference and are arranged within a common plane. This plane is oriented orthogonally to the longitudinal axis of a cylindrical extension of the housing in this area.

Furthermore, it can be provided that the guide section for guiding the at least one locking element is designed in the form of a cylindrical section which extends along the locking unit in such a way that the at least one locking element is secured against displacement in the direction of the center of the cylindrical section in the closed position of the locking unit by resting on the surface of the cylindrical section, wherein the cylindrical section has a taper in one region, in particular in the form of a groove, which is arranged in such a way that in the open position of the locking unit the at least one locking element can be moved in the direction of the center of the cylindrical section so that engagement in the connecting body can be released. The transition is preferably smooth, in particular continuous.

In particular, it may be provided that the lock also has a mechanical movable connection, in particular in the form of a chain, which inseparably connects one end of the base body to one end of the connecting body, so that a closed loop is formed by closing the connecting body with the base body. The term “inseparable” means that separation can only take place by destroying/damaging the component in question.

Furthermore, it can be provided that the computing unit is set up to receive the signal by the energy conversion unit and to evaluate it after receipt, whereby an opening process is triggered if it matches a predeterminable reference signal by waiting for a period of time until a set amount of energy is received by a mobile device by means of the energy conversion unit, whereby the opening process is triggered by the computing unit by controlling the electric motor to rotate the cam disk into the release position.

In particular, it may be provided that the electric motor and the locking unit are arranged in the housing, the housing having a cylindrical opening in which the second force means followed by the electric motor and the locking unit is inserted, the at least one locking element also being held between the housing and the locking unit.

Furthermore, it may be provided that the desired amount of energy is selected to be at least high enough to supply the electric motor 5 with sufficient energy to carry out the rotation of the cam disk into the release position, wherein the lock is preferably free of external charging connections.

### BRIEF DESCRIPTION OF THE DRAWINGS

The invention is explained in more detail below with reference to an exemplary and non-limiting embodiment, which is illustrated in the figures. It shows

FIG. 1 shows a schematic representation of a lock according to the invention including the chain connected to it,

FIG. 2 a representation of the lock according to FIG. 1 without external housing and without chain,

FIG. 3A a further view of the lock in an open state,

FIG. 3B a sectional view of the lock according to the sectional line AA from FIG. 3A,

FIG. 4A a further view of the lock in a closed state,

FIG. 4B a sectional view of the lock according to sectional line AA from FIG. 4A,

FIGS. 4C and 4D show how the lock is opened,

FIG. 5A a detailed view of the base body of the lock, in which a locking unit is in a closed position,

FIG. 5B a detailed view of the base body of the lock, in which a locking unit is in an open position,

FIG. 6 a detailed view of components of the locking unit,

FIG. 7 an exploded view of components of the locking unit,

FIG. 8 a further schematic exploded view of components of the locking unit,

FIG. 9A a detailed view of a cam disk that can be inserted in the locking unit, namely in a closed position,

FIGS. 9B and 9C a rotary movement of this cam disk towards an open position, and

FIG. 9D a rotary movement of the cam disk up to a stop.

### DETAILED DESCRIPTION OF THE INVENTION

In the following figures, unless otherwise indicated, identical reference signs denote identical features.

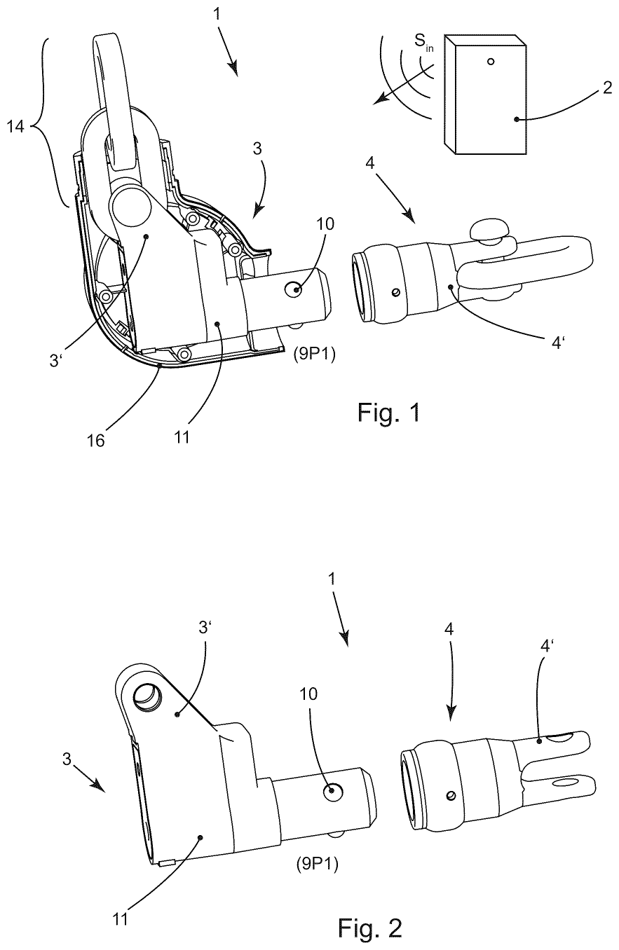

FIG. 1 shows a schematic representation of a mobile lock 1 according to the invention including a chain 14 connected thereto, which is only indicated by individual chain links in the present case, but is of course designed as a single continuous strand in practical use. The chain 14 connects one end 3′ of the base body 3 with one end 4′ of the connecting body 4 in an inseparable manner, so that a closed loop (not shown in FIG. 1) is formed by closing the connecting body 4 with the base body 3.

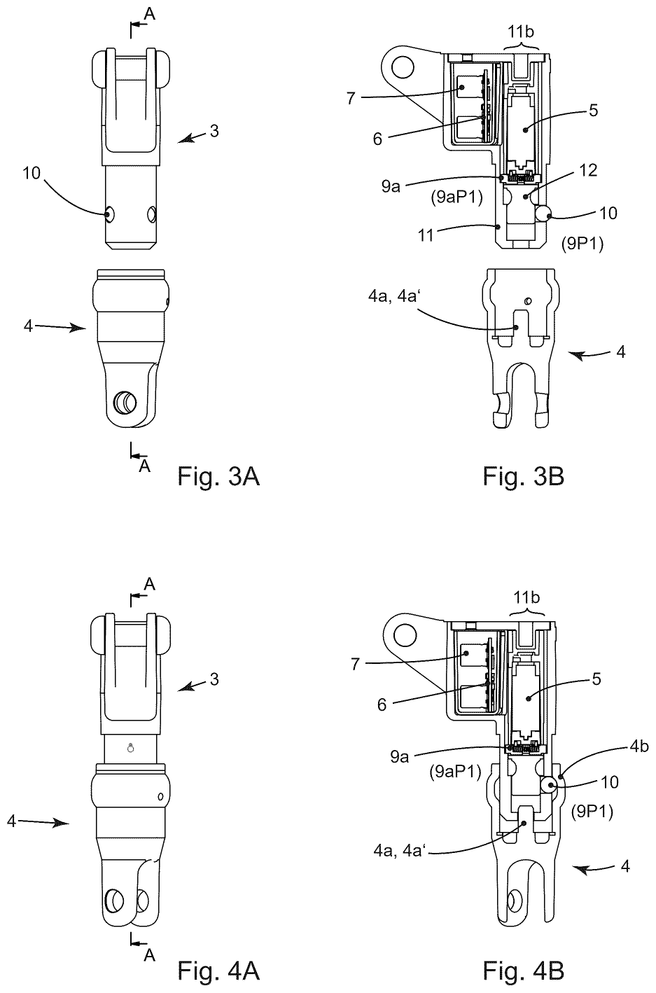

The lock 1 can be controlled wirelessly by a mobile device 2. It comprises a base body 3 and a connecting body 4 that can be locked to the base body 3. The base body 3 has a housing 11 that is partially enclosed by an outer housing 16. In conjunction with FIG. 3B, it should be mentioned that the base body 3 also has an electric motor 5, a computing unit 6 for controlling the electric motor 5 and an energy conversion unit 7 for converting electromagnetic energy that can be transmitted via a mobile device 2. This energy can be transmitted via NFC technology or QI technology, for example. The energy conversion unit 7 converts this energy into an electrical voltage for supplying the electric motor 5 and the computing unit 6. The electromagnetic energy emitted by the mobile device contains the subset or signal Sin, which is received and converted by the energy conversion unit 7.

The computing unit 6 is set up to control the electric motor 5 as a function of a signal Sin received by a mobile device 2. This means that this signal Sin can contain not only energy, but also identification and/or control information that can be used to configure the lock 1, identify the mobile device 2 and, if the identification is correct, control the electric motor 5 in such a way that the lock 1 is transferred from a closed state to an open state.

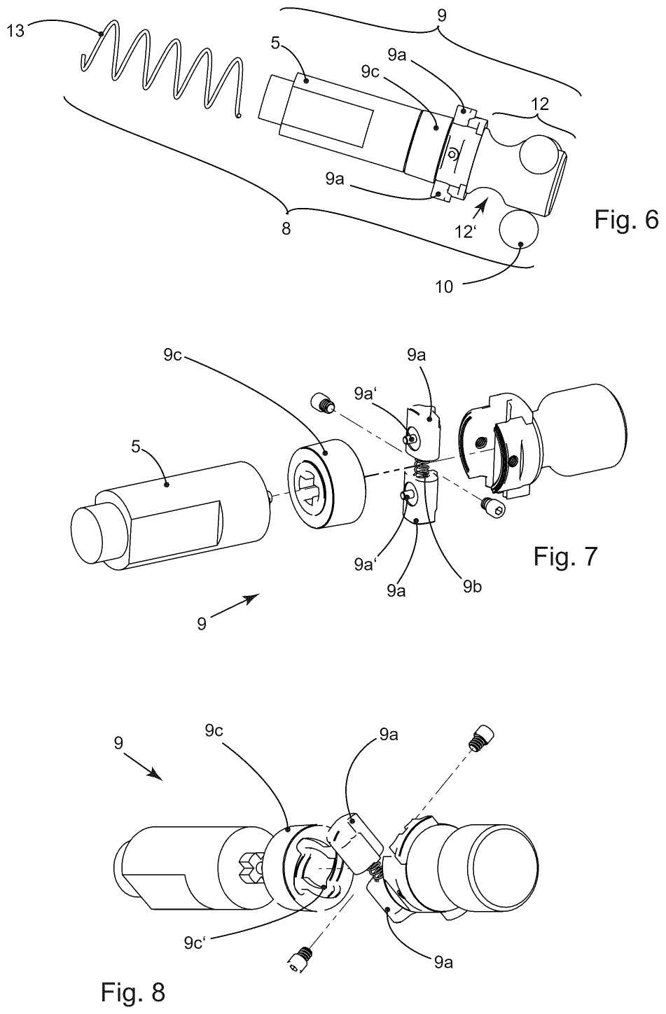

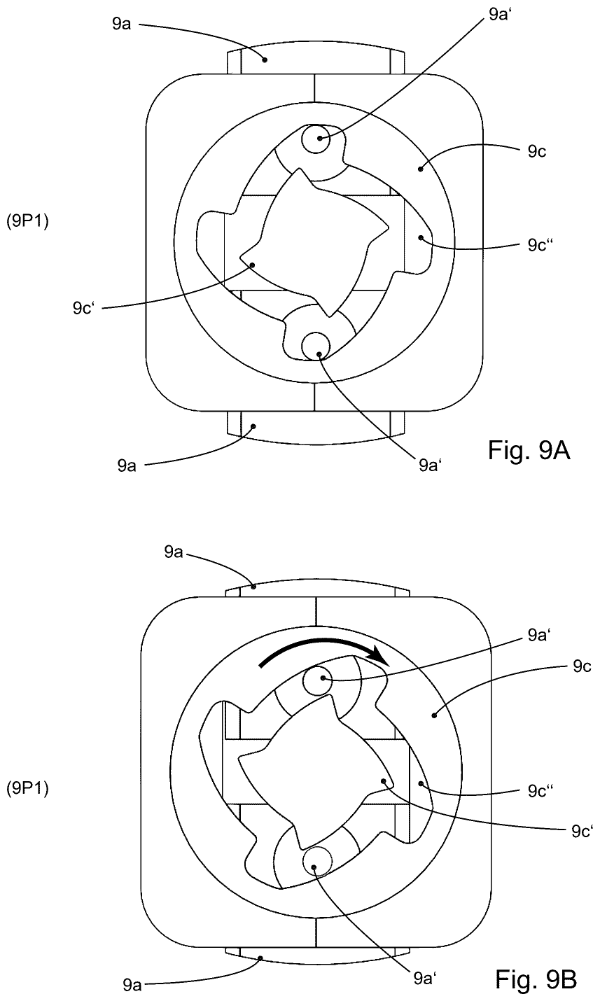

The lock 1 also comprises a mechanical locking system 8 (see FIG. 6). The locking system in turn comprises a locking unit 9 that can be moved in relation to the housing 11 and at least one locking element 10 coupled to it.

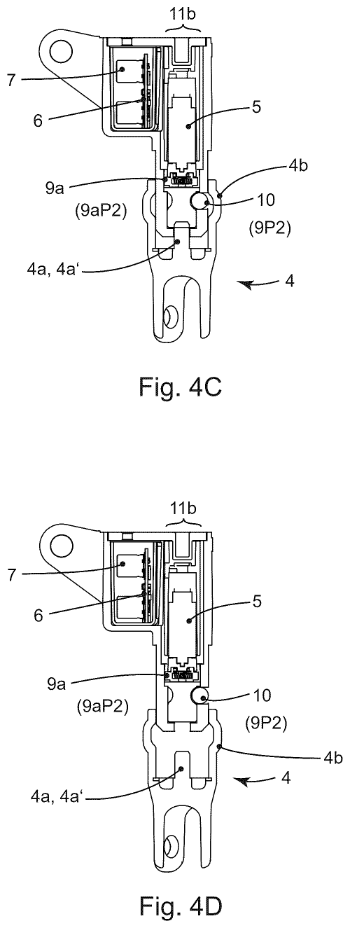

The locking unit 9 has the following: At least one locking bolt 9a, a first force means 9b (see FIG. 7) for exerting a force, in particular a spring element, which acts on the at least one locking bolt 9a and exerts a force effect on it, which presses the at least one locking bolt 9a towards an end position 9aP1 (see, for example, FIGS. 3B and 4B).

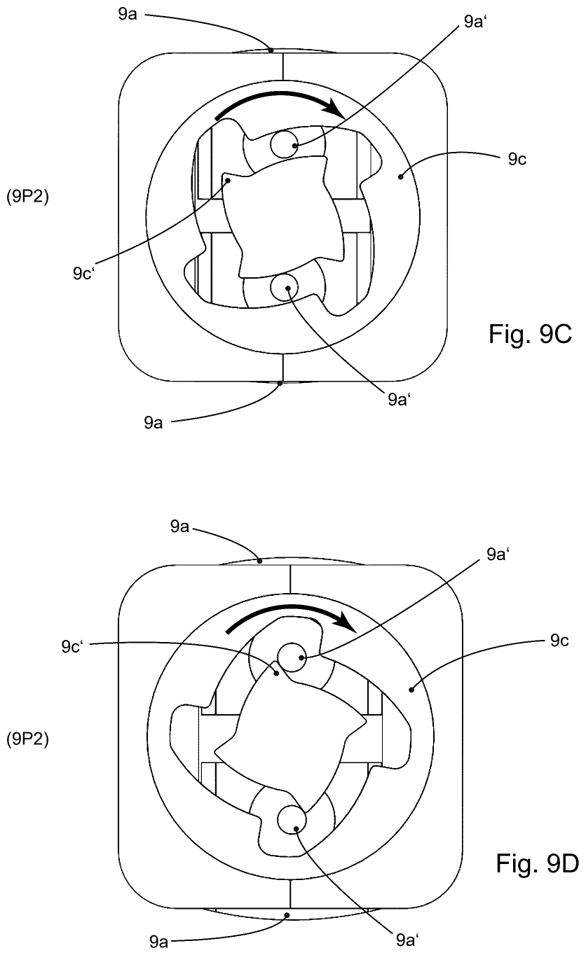

A cam disk 9c is set up to guide the bolts 9a and is rotatably connected to the electric motor 5. FIGS. 9A to 9D clearly show that the locking bolt 9a is mechanically coupled to the cam disk 9c, so that at least one locking bolt 9a can be moved away from the end position 9aP1 towards a release position 9aP2 by a rotary movement of the cam disk 9c against the force of the first force means 9b. This mechanical coupling takes place via a pin 9a′ of the respective locking bolt 9a, which is guided in a guide slot 9c″ of the cam disk 9c.

The cam disk 9c has at least one mechanical stop 9c′, which limits a rotary movement to be performed, which is provided for transferring the at least one locking bolt 9a from the end position 9aP1 to the release position 9aP2. In the present case, the stop 9c′ can be designed in such a way that a rotary movement to be performed is limited and at the same time, after the rotary movement has been completed, the transition of the at least one locking bolt 9a from a release position 9aP2 to the end position 9aP1 is released by the cam disk 9c, so that when the locking unit 9 is in the closed position 9P1, the at least one locking bolt 9a is pressed into the end position 9aP1 with the aid of the first force means 9b.

The cam disk 9c can have four sections, each with a stop 9c′, which sections are offset from each other by 90° and are otherwise identical, so that a rotary movement for transferring the at least one locking bolt 9a from the release position 9aP2 to the end position 9aP1 takes place over an angular range of 90°.

It may be provided that the lock 1 has exactly two locking bolts 9a, which are arranged opposite one another and the first force means 9b is in the form of a compression spring arranged between these locking bolts 9a, which presses the locking bolts 9a apart. This makes manipulation from the outside even more difficult.

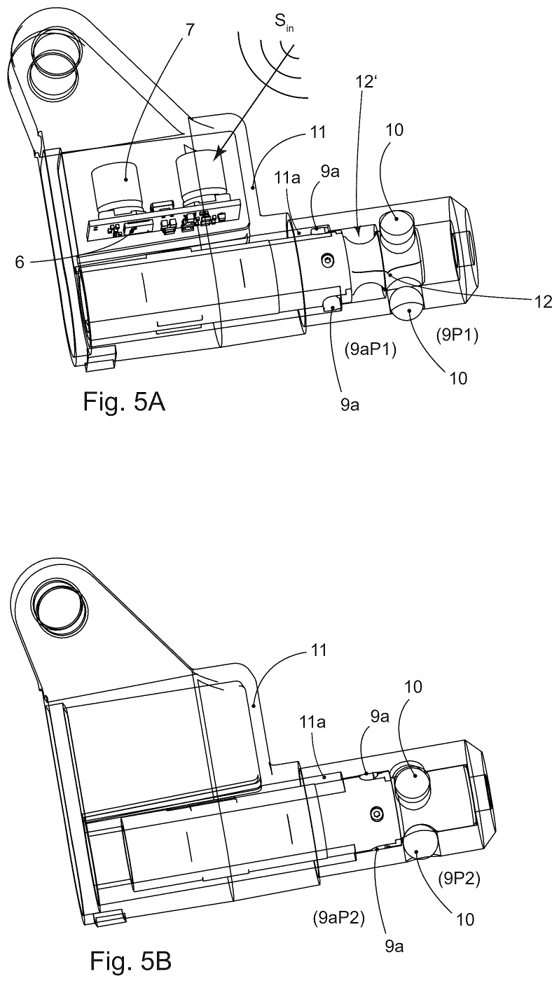

With reference to FIG. 5B, it should be mentioned that in the release position 9aP2 of the at least one locking bolt 9a, the locking unit 9 is displaceable with respect to the housing 11, namely from a closed position 9P1 (see FIG. 5A) into an open position 9P2 and vice versa, and wherein in the end position 9aP1 of the at least one locking bolt 9a, the locking unit 9 is fixed in the closed position 9P1.

This fixing takes place by engagement in a groove 11a, whereby a spring 13 shown in FIG. 6 can be provided, which presses the locking unit 9 towards the end of the groove 11a and thus positions the locking unit 9 firmly. As soon as the locking bolts 9a retract by turning the rotating disk 9c, the engagement of the bolts 9a in the groove 11a is released and the locking unit 9 can be moved into the open position 9P2 by means of the spring force of the spring 13.

The locking unit 9 has a guide section 12 along which locking elements 10, which are designed as balls in the present case, are guided. The guide section 12 is designed as a cylindrical section which extends along the locking unit 9 in such a way that the at least one locking element 10 is secured against displacement in the direction of the center point of the cylindrical section in the closed position 9P1 of the locking unit 9 by resting on the surface of the cylindrical section, wherein the cylindrical section has a taper 12′ in a region, in particular in the form of a groove, which is arranged in such a way that in the open position 9P2 of the locking unit 9 the at least one locking element 10 is moved in the direction of the center of the cylindrical section. In this way, an engagement with a connecting body 4 pushed onto the base body 3 (see, for example, in FIG. 4B in the closed position 9P1) can be released, since a corresponding engagement area 4b of the connecting body 4 is no longer blocked by the locking elements 10, but can now be released from the base section 3 by displacement along the base section. This process is shown in figures FIG. 4B to FIG. 4D.

It may be provided that the lock 1 has three locking elements 10, each of which is designed as a ball, whereby the housing 11 is cylindrical in the area of the locking elements 10 and the balls are arranged on the circumference of the housing 11 in such a way that they are offset from one another by 120° along the circumference and are arranged within a common plane. This plane can be oriented orthogonally to the longitudinal axis of a cylindrical extension of the housing in this area.

As already mentioned, the locking unit 9 has a guide section 12 which is in mechanical engagement with the locking element 10 in such a way that, in the closed position 9P1 of the locking unit 9, the at least one locking element 10 is secured against displacement with respect to the housing 11 in such a way that the locking element 10 can be locked with the base body 3, so that a connecting body 4 mechanically coupled to the base body 3, in particular pushed onto the latter, is locked to the base body 3 by mechanical engagement of the at least one locking element 10 in the connecting body 4 and secured against opening. In an open position 9P2, on the other hand, the at least one locking element 10 can be moved along the guide section 12 in relation to the housing 11 or transferred into the groove 12′, so that the mechanical engagement with the connecting body 4 can be released.

FIG. 9A shows a detailed representation of a cam disk 9c which can be inserted in the locking unit 9, namely in a closed position 9P1, FIGS. 9B and 9C show a rotary movement of this cam disk 9c towards an open position 9P2 and FIG. 9D shows a rotary movement of the cam disk 9c up to the stop 9c′.

In FIG. 6 it can be seen that the lock has a second force means 13 that is arranged inside the housing 11, the force means 13 exerting a force on the locking unit 9 that pushes the locking unit 9 in the direction of the open position 9P2. In order to minimize the electrical energy consumption of the lock 1, the computing unit 6 for controlling the electric motor is configured in such a way that the electric motor 5 is controlled exclusively for transferring the at least one locking bolt 9a from the end position 9aP1 to the release position 9aP2, and wherein the second force means 13 is dimensioned such that by transferring the locking bolt 9a into the release position 9aP2, the locking unit 9 is pressed from the closed position 9P1 into the open position 9P2 solely by the force of the second force means. With reference to FIGS. 3B and 4B, it should be mentioned that the connecting body 4 has a coupling section 4a, in particular in the form of a projection 4a′, which coupling section 4a is set up to contact the locking unit 9 when the connecting body 4 is manually pushed onto the base body 3 and to move it from the open position 9P2 to the closed position 9P1 against the force of the second force means 13. This can be done, for example, by a user manually pushing the connecting body 4 onto the base body 3.

It is possible that the electric motor 5 is equipped with a self-locking gear.

With regard to FIG. 5A, it should be mentioned that the computing unit 6 is set up to receive the signal Sin by the energy conversion unit 7 and to evaluate it after receipt, whereby an opening process is triggered if it matches the predeterminable reference signal by waiting for a period of time until a desired amount of energy is received by a mobile device by means of the energy conversion unit 7, whereby the opening process is triggered by the computing unit 6 by controlling the electric motor 5 to rotate the cam disk 9c into the release position 9aP2. If a user has, for example, paired their smartphone with the lock 1, identification of the smartphone in question can be used to unlock the lock 1. Due to the exemplary technical structure shown here, the bolts 9a would release the displacement of the locking unit 9, which in turn causes the spring 13 to displace the locking unit 9, so that the locking element 10 is released and the front end of the locking unit 9 comes into contact with the projection 4a′ of the connecting body 4, so that the latter is at least partially pushed down from the base body 3. In this way, opening is clearly recognizable for a user and can be reversed by reversing this movement by manually pushing the connecting body 4 against the force of the spring 13 onto the base body 3 without consuming electrical energy. Closing can be done completely manually and without establishing a connection with a mobile device 2.

The set energy quantity is at least high enough to supply the electric motor 5 with sufficient energy to rotate the cam disk 9c into the release position 9aP2, whereby the lock 1 is preferably free of external charging connections.

In FIGS. 3B and 4B it can be seen that the electric motor 5 and the locking unit 9 are arranged in the housing 11, the housing 11 having a cylindrical opening 11b. The second force means 13 not shown therein is contained therein, which is inserted followed by the electric motor 5 and by the locking unit 9, wherein the at least one locking element 10 is also held between the housing 11 and the locking unit 9, so that the locking element 10 cannot become detached from the base body 3 even when it is removed from the connecting body 4.

The invention is not limited to the embodiments shown, but is defined by the entire scope of protection of the claims. Individual aspects of the invention or the embodiments can also be taken up and combined with one another. Any reference signs in the claims are exemplary and serve only to make the claims easier to read without restricting them.

1. A mobile lock for securing a mobile object, wherein the lock can be controlled wirelessly by a mobile device, wherein the lock has a base body and a connecting body which can be locked to the base body, wherein the base body comprises the following:
a housing,
an electric motor
a computing unit for controlling the electric motor, the computing unit being set up to control the electric motor as a function of a signal received by a mobile device,
an energy conversion unit for converting electromagnetic energy which can be transmitted via a mobile device, in particular electromagnetic energy which can be transmitted via NFC technology or QI technology, into an electrical voltage for supplying the electric motor and the computing unit,
a mechanical locking system comprising a locking unit displaceable in relation to the housing and at least one locking element coupled thereto,
characterized in that the locking unit has the following:
at least one locking bolt,
a first force means for exerting a force, in particular a spring element, which acts on the at least one locking bolt and exerts a force on the latter which presses the at least one locking bolt towards an end position,
a cam disk rotatably connected to the electric motor, wherein the at least one locking bolt is mechanically coupled to the cam disk, so that the at least one locking bolt can be moved away from the end position towards a release position by a rotary movement of the cam disk counter to the force of the first force means,
wherein in the release position of the at least one locking bolt, the locking unit is displaceable with respect to the housing, namely from a closed position into an open position and vice versa, and wherein in the end position of the at least one locking bolt, the locking unit is fixed in the closed position, and
wherein the locking unit has a guide portion which is in mechanical engagement with the locking element, in such a way that in the closed position of the locking unit the at least one locking element is secured against displacement with respect to the housing in such a way so that a connecting body mechanically coupled to the base body, in particular pushed onto the latter, is locked to the base body (3) and secured against opening by mechanical engagement of the at least one locking element in the connecting body,
and in an open position of the locking unit, the at least one locking element is displaceable with respect to the housing along the guide section, so that the mechanical engagement with the connecting body can be released.

2. The mobile lock according to claim 1, wherein a second force means is provided within the housing, which exerts a force on the locking unit which presses the locking unit in the direction of the open position.

3. The mobile lock according to claim 2, wherein, in order to minimize the electrical energy consumption of the lock, the computing unit for controlling the electric motor is configured in such a way that the electric motor is controlled exclusively for transferring the at least one locking bolt from the end position to the release position, and wherein the second force means is dimensioned such that by transferring the locking bolt into the release position, the locking unit is pressed from the closed position into the open position solely by the force of the second force means.

4. The mobile lock according to claim 3, wherein the connecting body has a coupling section, in particular in the form of a projection, which coupling section is set up to contact the locking unit when the connecting body is manually pushed onto the base body and to transfer it from the open position into the closed position against the force of the second force means.

5. The mobile lock according to claim 1, wherein the electric motor is equipped with a gear which is designed to be self-locking.

6. The mobile lock according to claim 1, wherein the cam disk has at least one mechanical stop which limits a rotary movement to be performed, which is provided for transferring the at least one locking bolt from the end position into the release position.

7. The mobile lock according to claim 6, wherein the stop is designed in such a way that a rotary movement to be performed is limited and at the same time, after the rotary movement has been completed, the transition of the at least one locking bolt from the release position to the end position is released by the cam disk, so that when the locking position of the locking unit is present, the at least one locking bolt is pressed into the end position with the aid of the first force means.

8. The mobile lock according to claim 6, wherein the cam disk has four sections, each with a stop, which sections are offset by 90° relative to one another and are otherwise identical, so that a rotary movement for transferring the at least one locking bolt from the release position to the end position takes place over an angular range of 90°.

9. The mobile lock according to claim 1, wherein the lock has exactly two locking bolts which are arranged opposite one another and the first force means is designed in the form of a compression spring which is arranged between these locking bolts and presses the locking bolts apart.

10. The mobile lock according to claim 1, wherein the lock has three locking elements which are each designed as a ball, wherein the housing is cylindrical in the region of the locking elements and the balls are arranged on the circumference of the housing in such a way that they are offset from one another by 120° along the circumference and are arranged within a common plane.

11. The mobile lock according to claim 1, wherein the guide section for guiding the at least one locking element is designed in the form of a cylindrical section which extends along the locking unit in such a way that, in the closed position of the locking unit, the at least one locking element is secured against displacement in the direction of the center point of the cylindrical section by resting on the surface of the cylindrical section, wherein the cylindrical section has a taper in a region, in particular in the form of a groove, which is arranged in such a way that in the open position of the locking unit the at least one locking element can be moved in the direction of the center of the cylindrical section so that an engagement in the connecting body can be released.

12. The mobile lock according to claim 1, wherein the lock also has a mechanical movable connection, in particular in the form of a chain, which inseparably connects one end of the base body to one end of the connecting body, so that a closed loop is formed by closing the connecting body with the base body.

13. The mobile lock according to claim 1, wherein the computing unit is set up to receive the signal by the energy conversion unit and to evaluate it after receipt, wherein an opening operation is triggered if it matches a predeterminable reference signal by waiting for a period of time, until a desired amount of energy is received by a mobile device by means of the energy conversion unit, the opening operation being triggered by the computing unit by controlling the electric motor to rotate the cam disk into the release position.

14. The mobile lock according to claim 13, wherein the desired amount of energy is selected at least high enough to supply the electric motor with sufficient energy to carry out the rotation of the cam disk into the release position, wherein the lock is free of external charging connections.

15. The mobile lock according to claim 1, wherein the electric motor as well as the locking unit is arranged in the housing, wherein the housing comprises a cylindrical opening in which the second force means followed by the electric motor as well as by the locking unit is inserted, wherein the at least one locking element is furthermore held between the housing and the locking unit.
